(19) United States
(12) Patent Application Publication
(10) Pub. No.: US 2013/0286461 A1
(43) Pub. Date: Oct. 31, 2013

(54) SYNERGISTIC REVERSIBLE CHROMISM

(71) Applicants: Michael D. Broekhuis, Wyoming, MI (US); Harlan J. Byker, West Olive, MI (US); Christopher D. Anderson, Grand Rapids, MI (US); Curtis J. Liposcak, Madison, WI (US)

(72) Inventors: Michael D. Broekhuis, Wyoming, MI (US); Harlan J. Byker, West Olive, MI (US); Christopher D. Anderson, Grand Rapids, MI (US); Curtis J. Liposcak, Madison, WI (US)

(73) Assignee: PLEOTINT, L.L.C., West Olive, MI (US)

(21) Appl. No.: 13/870,461

(22) Filed: Apr. 25, 2013

Related U.S. Application Data
(60) Provisional application No. 61/639,499, filed on Apr. 27, 2012.

(51) Int. Cl. G02F 1/01

(52) U.S. Cl. CPC G02F 1/0147
USPC 359/288

(57) ABSTRACT

A multilayer laminate and, more particularly a variable transmission window, which comprises:
a) a thermochromic layer
b) a photochromic layer
   wherein the thermochromic layer exhibits a net increase in its ability to absorb UV, visible, and/or near infrared light energy as the temperature of the system increases and a net decrease in its ability to absorb UV, visible and/or near infrared light energy as the temperature of the system decreases within the active range of the thermochromic layer.

### CROSS-REFERENCE TO RELATED APPLICATION

This application claims the benefit of U.S. Provisional Application 61/639,499 filed Apr. 27, 2012.

### BACKGROUND

This application is directed to the combination of thermochromic, (TC), and photochromic, (PC), systems incorporated into solar energy attenuation applications and this application is particularly directed to variable transmission windows. Both TC and PC systems have been explored for use in solar energy attenuation applications and variable transmission windows. This invention discloses novel combinations of PC and TC systems and structures wherein there is a synergistic relationship between these two systems. This synergistic relationship improves service life and simultaneously improves performance with regard to sunlight attenuation of windows that incorporate the systems. These windows better minimize heat load while maximizing daylighting inside a building.

U.S. Pat. No. 7,911,676 describes a combination of TC systems and PC systems wherein the TC system changes from absorbing more ultraviolet (UV) light at low temperatures to absorbing less UV light at high temperatures. This type of TC system may screen out some of the UV light at lower temperatures so that less PC material is activated to the colored state. This is of interest when the thermal back reaction for bleaching of the PC materials is slower at the lower temperatures. Then when the systems are warmer the TC materials switch to allow more UV light to reach the PC materials. This is desired when the thermal back or bleaching rate of the PC materials is faster due to the higher temperatures. In this way the TC system helps the PC system to have more uniform darkening throughout a range of temperatures thus helping to minimize the problem of more PC darkening when cold and less darkening when warm.

Photochromic materials undergo photo-induced changes in their ability to absorb electromagnetic radiation, especially photo-induced changes in visible light absorption. Most photochromic materials of interest absorb ultraviolet light which directly causes a transformation such as a change in molecular configuration or a long lived photo-induced charge transfer state. The ultraviolet light-induced transformation results in a change in the absorption spectrum of the photochromic material which normally results in an increase in visible light absorption. Thus in most cases the absorption of UV light causes the photochromic material to change from a colorless or nearly colorless state to a colored or more darkly colored state.

In some cases photochromic materials are bleached, (that is return to their less visible light absorbing state), by absorbing light of certain wavelengths. However in many cases the photochromic materials bleach over a period of time by a thermally driven back reaction. Normally this thermally driven back reaction is not considered a thermochromic process, as the light has taken the system away from thermodynamic equilibrium and the thermal bleaching process in simply restoring that thermodynamic equilibrium.

In most applications, low concentrations of photochromic materials are placed in or dissolved in a matrix. The matrix may be an inorganic glass or a polymeric material such as a plastic film or sheet. Typical concentrations are in the 0.1 to 10 weight percent photochromic material to matrix.

Particularly useful photochromic materials of interest in the present invention are those that absorb UV light and change from colorless or nearly colorless to colored or more darkly colored because of the UV light absorption. They also bleach by a thermal back reaction over a period of seconds or minutes. The preferred photochromic films, sheets or layers contain preferred photochromic materials in a plastic film or sheet.

Thermochromic materials undergo changes in their ability to absorb light of various wavelengths as the temperature of the materials change over some useful range of temperatures. The change may be abrupt on passing through a certain threshold temperature or, in accordance with particularly useful aspects, is continuously variable over a range of temperatures. Preferably, the change in light absorption is reversible.

A particularly useful type of thermochromic materials for use in the thermochromic layers of the present application are termed ligand exchange thermochromic, LETC, materials. LETC materials have thermochromic activity which results in a reversible change in absorbance of electromagnetic radiation as the temperature of the system is reversibly changed. That the change is reversible means that the absorbance increase as the temperature increases is the same as the absorbance decrease as the temperature decreases for a cycle of temperature increase and decrease over a given temperature range. LETC materials of interest for use in practical thermochromic systems, layers and devices are stable on repeated temperature cycling for some useful number of cycles. Particularly useful LETC materials and systems have a net increase in their ability to absorb UV, visible and/or NIR light energy as the temperature of the system increases and a net decrease in their ability to absorb UV, visible and/or NIR light energy as the temperature of the system decreases for temperatures within the active range of the system. The active temperature range of the system is determined by the thermodynamic properties of the LETC reactions. For many particularly useful applications, like sunlight responsive thermochromic windows, the active temperature range includes −20° C. to 100° C.

In accordance with certain embodiments, it is preferred that the electromagnetic radiation, for which absorbance changes occur, be in the ultraviolet as well as the visible and/or NIR portions of the electromagnetic spectrum. The change in light absorption on heating of the LETC systems generally results in a change from one color to another color and/or a darkening of the color of the system. If the increase in light absorption is predominantly in the NIR, the LETC system may still be very useful even though little or no visual color change occurs. However, in accordance with particularly useful applications of the LETC systems or layers disclosed herein, there is a net increase in the ability of the system to absorb incident UV, visible and/or NIR sunlight power (or energy over time), as the temperature of the system increases from T₁ to T₂ and an equal net decrease in the ability of the system to absorb incident UV, visible and/or NIR sunlight power (or energy over time), as the temperature of the system decreases from T₂ to T₁. In most cases, this means that the LETC systems become darker in color as the temperature of the system increases and lighter as the temperature of the system decreases. In general there is no change in the amount of light scattered or reflected by the LETC system itself.

U.S. Pat. Nos. 7,525,717; 7,538,931; 7,542,196 and 8,018,639 describing LETC materials, systems, layers and devices are hereby incorporated into this disclosure by reference. LETC systems comprise one or more than one transition metal ions such as Fe(II), Co(II), Ni(II) or Cu(II) ions, which experience thermally induced changes in the nature of the complexation or coordination around the transition metal ion(s) and thereby the system changes its ability to absorb electromagnetic radiation as the temperature changes. As explained in U.S. Pat. Nos. 7,525,717; 7,538,931; 7,542,196 and 8,018,639; LETC systems employ so-called high epsilon ligands (H L's) and low epsilon ligands (L L's). Upon increasing the temperature of the thermochromic system, layer or device, one or more of the L L's will be displaced by one or more H L's to give a complex that absorbs more UV, visible and/or NIR radiation. Examples of L L's are diols, triols and certain hydroxy containing polymers like poly(vinyl butyral). Examples of H L's are chloride, bromide, iodide and molecules that coordinate to transition metal ions through one or more than one nitrogen, oxygen, phosphorus and sulfur atoms in the ligand molecules.

For the use of LETC systems in applications like variable transmission, energy saving windows, especially Sunlight Responsive Thermochromic, SRT™, windows, there is a demand for certain colors. While fixed tint windows which are gray, green, blue and bronze are in widespread use, the most desirable color, (or lack thereof), for variable tint windows is gray. This is especially true when the window is or is able to become heavily tinted as the view through a heavily tinted gray window maintains the same color rendition for objects viewed through the window as is maintained with a lightly tinted or nearly colorless window. Also it is highly desirable for the daylighting that comes in through the window to be color neutral so that people and objects illuminated by the incoming light have a normal appearance.

The present application describes systems and devices that are particularly useful when used in combination with the window constructions disclosed in U.S. Pat. Nos. 6,084,702; 6,446,402; 7,817,328 and 8,154,788. The contents of these patents are hereby incorporated into this disclosure by reference.

Of particular interest in the present application are thermochromic systems that increase their UV and short wavelength visible light absorption as the temperature of the system increases. Particularly useful thermochromic systems with this characteristic are based on Ni(II) and/or Co(II) ions and ligands such as iodide, compounds that coordinate through a nitrogen atom and compounds that coordinate through a phosphorus atom and combinations of these ligands. Preferred compounds that coordinate through a nitrogen atom include 5- or 6-membered nitrogen heterocycles. Preferred compounds that coordinate through a phosphorus atom include P(III) ligands including trialkylphosphine and triarylphosphine These thermochromic systems are preferably contained in a polymer film or sheet.

While under many circumstances, windows incorporating these TC systems respond effectively to direct sunlight so as to tint and reduce heat load and glare in buildings, there are times when the response of the purely TC systems is slower than desired. This occurs under circumstance such as when the sun is blocked from shining on the TC windows by clouds, trees, hills, adjacent buildings, overhangs or setback walls for a period of time and then suddenly the sunlight shines directly on the window. Lag time to heat the window structure of a purely TC system containing window may result in a higher than desirable solar transmission at times. Combing in a PC layer may be useful in blocking some of this solar transmission until the TC layer response is adequate. Also, sunlight responsive TC windows may not tint adequately to reduce heat load and glare when there are high wind loads on the window, especially in the upper floors of high-rise buildings, or in circumstances where there is substantial air movement past the window, especially for windows in moving vehicles. The combination of a TC system with a PC system has been found to provide better overall solar transmission control under these circumstances.

PC materials have been known for many years. Inorganic or organic PC materials may be used in the compositions and structures disclosed herein. Of particular interest are organic PC materials of the type that have been and those that are currently used in plastic ophthalmic lenses sold by Transitions Optical Incorporated of Pin ell as Park, Fla. and photochromic films such as VersaTint™ photochromic film available from PPG Industries, Inc. of Pittsburgh, Pa. PC materials of interest are described in several books, numerous journal article and numerous patents. Of particular interest are PC materials described in Photochromism, Techniques of Chemistry Volume III edited by Glenn H. Brown, published by John Wiley & Sons, Inc. (1971); Organic Photochromic and Thermochromic Compounds Volumes 1 and 2 by John C. Crano and Robert J. Guglielmetti published by Kluwer Academic/Plenum Publishers (1999) and Photochromism: Molecules and Systems by Heinz Dürr and Henri Bouas-Laurent published by Elsevier (2003). The relevant contents of these publications are hereby incorporated by reference. Examples of useful PC materials include spiropyrans, spirooxazines and so called chromenes incorporated into polymer films or sheets. A particularly useful PC film is VersaTint™ photochromic film. Other particularly useful PC materials are disclosed in U.S. Pat. Nos. 7,584,630; 7,560,056; 7,556,751; 7,556,750; 7,556,750; 7,320,826; 7,094,368; 6,630,597; 6,348,604; 6,106,744; 5,869,658; 5,753,146; 5,674,432; 5,658,501; 5,658,500; 5,651,923; 5,650,098; 5,645,767; 5,637,262; 5,578,252; 5,565,147; 5,552,090; 5,466,398; 5,458,814; 5,451,344; 5,395,567; 5,340,857; 5,330,686; 5,244,602, the contents of which are hereby incorporated by reference.

There are three main problems that prevent PC systems from being effectively used by themselves in variable transmission windows. The first problem relates to the long term photochemical stability of most PC materials especially when the materials are exposed to solar radiation at elevated temperatures. Thus the light that activates the PC system is often effective in degrading the system over a length of time. The second problem relates to the thermal back reaction that allows the PC systems to return to their clear state. The warmer the system becomes, the faster the thermal back reaction. Thus if the amount of radiation incident on a PC material is sufficient to cause the PC materials to darken and remains constant, the temperature of the PC material will increase over time and the steady state concentration of PC material in the darkened state will decrease due to the increased rate of the thermal back reaction at elevated temperatures. For many PC systems this means that little or no darkening is observed once the PC layer is heated above the range of 40° C. to 50° C. by sunlight exposure. This is important because any heavily tinted film (i.e., <25% visible light transmission), that effectively blocks solar heat load and glare, will reach temperatures in excess of the range of 40° C. to 50° C. when exposed to direct sunlight, unless there is significant air movement over the window. The third problem also relates to the thermal back reaction that allows the PC systems to return to their clear state. When the PC system is cool even a small amount of UV radiation may be effective in darkening the layer since the thermal bleaching back reaction is so slow. This results in an undesirable amount of darkening even on cloudy or overcast days or when the sun is not directly on the window.

### SUMMARY

In accordance with certain aspects of the present application, certain TC layers are placed between the sun and a PC layer to improve the overall performance for a window incorporating the layers and improve overall durability for the PC layer. In particular, we have discovered that a TC layer which always absorbs short wavelength UV light, but transmits some long wavelength UV light when the TC layer is cool, allows some activation or switching of PC materials or films that are inboard with regard to the sun and with respect to the TC layer. These TC systems and layers protect the PC layer from the more harmful short wavelength UV.

In accordance with another aspect, particular TC layers, as disclosed herein, as they warm up can be used to absorb almost all of the long wavelength UV and much of the short wavelength visible light which might also be harmful to the PC layer. Thus when the layers are warm the TC layer provides all or at least most of the darkening and TC layer protects the PC layer from essentially all harmful solar radiation. On the other hand when the layers are cool enough sunlight passes through the TC layer or layers to allow the PC layer or layers to tint or darken. If the PC layer is in thermal contact with one or more TC layers the PC layer may even provide improved sunlight responsiveness for the TC layer as the PC layer is the first to darken and be warmed by solar radiation and can transfer some of this heat to the TC layer.

Examples of the desirable spectral transmission characteristics of TC and PC layers useful in certain embodiments are illustrated in FIG. 27. In accordance with this example, this PC layer transmits less than 30% and therefore absorbs over 70% of the solar radiation between 370 nm and 300 nm. Normally these wavelengths would make the PC layer vulnerable to photodegradation. FIG. 27 also shows the spectral transmission of a TC layer of one embodiment of the invention that may be placed between the PC layer and the sun. This TC layer has the following composition: 2 weight % nickel(II) iodide; 1 weight % 4-(3-phenylpropyl)pyridine; 12.5 weight % tetrabutylammonium iodide; 3.5 weight % 2-butyl-2-ethyl-propanediol; 1 weight % Tinuvin 405; 13 weight % non-TC additives and 67 weight % poly(vinyl butyral). The TC layer at 25° C. has essentially 0% transmission at wavelengths shorter than 370 nm and protects the PC layer from exposure to these wavelengths when the TC layer is placed closer to the sun than the PC layer. The TC layer does transmit some of the solar radiation of wavelengths between about 410 nm and 370 nm which enables the PC layer to tint in response to sunlight under certain circumstances. That the PC layer absorbs radiation between about 410 nm and 370 nm can be seen in FIG. 27, as the transmission of the PC layer between about 410 nm and 370 nm is less than its maximum, which occurs at wavelengths longer than 410 nm. The radiation of wavelengths between about 410 nm and 370 nm is effective to darken the PC layer when the layers are at lower temperature like 25° C. As the TC layer warms to 45° C., the TC layer transmission decreases and less of the radiation of wavelengths between about 410 nm and 370 nm reaches the PC layer. At 65° C., a common temperature reached by an active TC layer in direct sunlight, the TC layer transmits almost no radiation between about 410 nm and 370 nm and thus the PC layer is protected from virtually all radiation that it might otherwise absorb. Since even wavelengths between 410 nm and 370 nm and even longer wavelengths can degrade the PC layer when it is warm this TC layer provides a previously unknown level of protection for the PC layer.

In addition to the highly desirable spectral characteristics that have been discovered for this combination of TC and PC layers, we have discovered that when the PC layer is placed between two TC layers it can serve a separator for the TC layers. Often there is a desire for variable transmission windows to tint with a neutral color. This may require more than one TC layer to achieve the required spectral coverage. Multiple TC layers are often needed with sunlight responsive TC layers for windows and the use of multiple TC layers to achieve neutral appearance of transmitted light is described in detail in U.S. Pat. No. 7,525,717. Whether to achieve neutral coloration or if multiple layers are desired for other reasons, the TC layers used in windows generally must be separated from each other in order to keep the different materials in each layer from diffusing into the other layers. If the materials intermix, they could change the appearance, performance and possibly the durability of each layer. The separator layer is generally a glass or plastic layer that is impermeable to the materials in the TC layers. Remarkably a VersaTint™ PC film (available from PPG Ind.) has been discovered to provide excellent separator properties for TC layers. When two TC layers separated by a VersaTint™ PC film are laminated between two pieces of glass and this laminate is heated for a prolonged period of time, the TC layers maintain good performance indicating little, if any, intermixing of the TC materials from the separated TC layers. Even more remarkable, the PC materials remain in the separator layer and the TC materials do not interfere with the performance the PC layer as the PC activity and performance of the PC layer is not degraded.

Preferred PC separator layers have PC materials incorporated into film or sheet made of polyolefins like various types of polyethylene and polypropylene, cellullosics like cellulose acetate butyrate and cellulose triacetate, polyester terephthalates like poly(ethylene terephthalate), acrylics, polycarbonates, cyclic olefin polymers and alternating layers of these polymers with PC material(s) in one or more of the polymers used in the alternating layers. Some particularly useful systems are described in more detail in co-pending U.S. Non-Provisional patent application Ser. No. 13/771,285 entitled, “An Enhanced Thermochromic Window Which Incorporates A Film With Multiple Layers Of Alternating Refractive Index,” the contents of which are hereby incorporated by reference.

We here disclose another advantageous aspect of the invention for the combination of TC and PC layers and systems. Not only can electromagnetic radiation degrade PC materials, but the combination of electromagnetic radiation and the presence of oxygen combine to degrade PC materials. In laminates with TC layers it is desirable to have an oxygen-free environment as there may be oxygen sensitive materials in the TC system. As disclosed in co-pending U.S. patent application Ser. No. 13/310,357, entitled “Anti-Yellowing for Thermochromic Systems”, the contents of which are hereby incorporated by reference, TC systems with appropriate additives can provide an oxygen-free environment. We have discovered that the durability of a PC layer is further enhanced when the PC layer is placed between layers, TC layers or other layers, which contain additives that react with and remove oxygen from the system. Thus the present invention includes placing the PC layer in an environment where there is no free molecular oxygen or reactive by-products due to oxidation by or photochemical interaction with molecular oxygen. In particular, we have devised a method of using PC layers in an environment free of destructive oxygen species including singlet oxygen.

The PC layer may also be protected from oxygen at the same time the PC layer is protected from UV at elevated temperatures by a configuration like that shown in FIG. 25. Here the gas spaces between the panes are filled with an inert gas like argon or krypton which minimizes the chance for presence of oxygen in the PC layer. In addition, gas spaces in an insulated glass unit can be in contact with and oxygen removing materials or oxygen absorbers which are placed, for example, in the spacer channel along with an optional desiccant. Oxygen removing materials or absorbers of particular interest are those that function in the absence of water, such as, but not limited to, PharmaKeep® or RP System® oxygen absorbers from Mitsubishi Gas Chemical America, Inc. (New York, N.Y.); oxygen absorbing versions of Activ-Films® from CSP Technologies (Auburn, Ala.) and Cryovac® OS Films—Rapid Headspace from Sealed Air Corporation (Elmwood Park, N.J.). Also of interest are iron-based systems, such as the FreshPax® system by Multisorb Technologies (Buffalo, N.Y.), and oxygen absorbers that are based upon the oxidation of ascorbic acid or ascorbate salts, such as, but not limited to, those available from Azorb Desiccant Solutions, LLC (Pine Grove, Pa.). Oxygen removing or absorbing systems such as those described in the following US patents would be well suited for this application: U.S. Pat. Nos. 5,744,056; 6,153,422; 8,003,751; 6,391,406 B1 and 7,985,456 B2, which are hereby incorporated by reference. Oxygen removing or absorbing systems described in the following US patent applications, but not limited to, would also be well suited for this application: Ser. Nos. 12/554,208 and 12/543,739 which are hereby incorporated by reference.

In addition, we have discovered that a PC layer like a VersaTint™ PC film can be surface treated to promote adhesion of the PC layer to TC layers without affecting the PC performance of the layer. This allows two TC layers to be laminated together with good adhesion with a PC film or layer and this tri-layer pre-laminate can subsequently be used to laminate sheets of glass together to make a pane for a window. The PC layer is preferably treated with atmospheric or vacuum plasma. A 24 inch wide by 36 inch long sample of VersaTint™ was atmospheric plasma treated on both sides at Enercon Industries Corporation of Menomonee Falls, Wis. The sample was treated with contact angle of 10 degrees at 300 kHz using a ceramic electrode. Feed speed was 50 feet per minute with a gap of 0.04 inches. The power supply was 2 KW with a watt density of 8. The gas mix used was 90% nitrogen, 7% oxygen, 3% acetylene gas. The surface energy of the film was increased from an initial dyne level of 33 to a final dyne level of 66. In general, surface treatment to promote adhesion may be done by atmospheric or vacuum based plasma treatments with various types of gas present. Alternatively, the surfaces may be pretreated with primers or coupling agents to promote adhesion between the PC layer and the TC layer or layers.

The combined PC and TC systems disclosed herein are useful in the following applications:

Building Components—examples include windows, doors, skylights, side lights, glass block, and interior or exterior shading devices.

Transportation Vehicles—examples include transparent or translucent viewing devices used in transportation vehicles such as ships, trains, buses, automobiles, trucks, and aircraft. Viewing devices include windshields, side lights, moonroofs, sunroofs, panoramic roofs, and rear windows.

Heavy Equipment—examples include transparent or translucent viewing devices used in heavy equipment such as to dump trucks, semi-trucks, cement mixers, military trucks, excavators, fork trucks, backhoes, bulldozers, tractors, and combines. Viewing devices include windshields, side lights, moon roofs, sun roofs, panoramic roofs, and rear windows.

Ophthalmic Devices—examples include sunglasses, corrective lenses, and safety glasses.

The present application discloses a multilayer laminate system comprising a thermochromic layer and a photochromic layer wherein the thermochromic layer exhibits a net increase in its ability to absorb UV, visible and/or NIR light energy as the temperature of the system increases and a net decrease in its ability to absorb UV, visible and/or NIR light energy as the temperature of the system decreases for temperatures within the active range of the system.

Another manifestation of this disclosure relates to a multilayer laminate as set forth above comprising two or more than two thermochromic layers and wherein the multilayer laminate is laminated between rigid substrates of glass or plastic.

In accordance with another aspect, the present application provides a multilayer plastic laminate comprising two or more than two thermochromic layers and one or more than one separator layer wherein at least one of the separator layers is a photochromic film and wherein the multilayer plastic laminate is laminated between rigid substrates of glass or plastic and wherein one or more than one of the substrates has a hard coat low-e coating on an exterior surface.

In yet another manifestation, the laminates described above are used as monolithic windows installed in a building. More particularly, the laminate may be used as the interior pane or the exterior pane of a double pane insulated glass unit wherein at least one TC film is positioned between the outside of the window and the PC layer.

In accordance with another aspect, the present application provides a laminate comprising at least one thermochromic layer between glass or plastic substrates wherein the laminate is the interior or the exterior pane of a double pane insulated glass unit and the insulated glass unit comprises a suspended PC film which is effective to divide the gas space into two compartments.

Any of the foregoing aspects of the present application may include one or more than one hard coat and/or soft coat low-e layer on any gas or vacuum exposed surface of any substrate or any gas or vacuum exposed surface of a film.

The present application also provides a system, series of layers, device or window in which a PC film is a separator for thermochromic layers.

### BRIEF DESCRIPTION OF THE DRAWINGS

FIG. 1A is a cross-sectional view of a thermochromic and photochromic laminate or co-extrusion whereby the thermochromic and photochromic systems are separate layers and additionally the photochromic layer can serve as a separator for the adhesive layer which may contain an additional thermochromic system;

FIG. 1B is a cross-sectional view of FIG. 1A with the addition of a spectrally selective coating;

FIG. 1C is a cross-sectional view of FIG. 1A with the addition of a removable spectrally selective film;

FIG. 1D is a cross-sectional view of FIG. 1A with the addition of a spectrally selective coating and removable spectrally selective film;

FIG. 2A is a cross-sectional view of a thermochromic and photochromic laminate or co-extrusion whereby the exterior thermochromic and photochromic with a possible secondary thermochromic system incorporated into a single layer are segregated by a suitable separator layer;

FIG. 2B is a cross-sectional view of FIG. 2A with the addition of a spectrally selective coating;

FIG. 2C is a cross-sectional view of FIG. 2A with the addition of a removable spectrally selective film;

FIG. 2D is a cross-sectional view of FIG. 2A with the addition of a spectrally selective coating and removable spectrally selective film;

FIG. 3A is a cross-sectional view of a thermochromic and photochromic laminate or co-extrusion whereby the exterior thermochromic, photochromic, and adhesive layer which may contain an additional thermochromic system are segregated by suitable separator layers;

FIG. 3B is a cross-sectional view of FIG. 3A with the addition of a spectrally selective coating;

FIG. 3C is a cross-sectional view of FIG. 3A with the addition of a removable spectrally selective film;

FIG. 3D is a cross-sectional view of FIG. 3A with the addition of a spectrally selective coating and removable spectrally selective film;

FIG. 4A is a cross-sectional view of a thermochromic and photochromic laminate or co-extrusion whereby the exterior thermochromic, adhesive layer which may contain an additional thermochromic system, and photochromic layer are segregated by suitable separator layers;

FIG. 4B is a cross-sectional view of FIG. 4A with the addition of a spectrally selective coating;

FIG. 4C is a cross-sectional view of FIG. 4A with the addition of a removable spectrally selective film;

FIG. 4D is a cross-sectional view of FIG. 4A with the addition of a spectrally selective coating and removable spectrally selective film;

FIG. 5A is a cross-sectional view of a thermochromic laminate or co-extrusion whereby the exterior thermochromic and adhesive layer which may contain an additional thermochromic system are segregated by a suitable separator and photochromic layer is attached to the interior side of the substrate;

FIG. 5B is a cross-sectional view of FIG. 5A with the addition of a spectrally selective coating;

FIG. 5C is a cross-sectional view of FIG. 5A with the addition of a removable spectrally selective film;

FIG. 5D is a cross-sectional view of FIG. 5A with the addition of a spectrally selective coating and removable spectrally selective film;

FIG. 6A is a cross-sectional view of a thermochromic laminate or co-extrusion whereby the exterior thermochromic, adhesive layer which may contain an additional thermochromic system are segregated by a suitable separator and photochromic layer is attached to the adhesive layer to structurally function as the interior substrate;

FIG. 6B is a cross-sectional view of FIG. 6A with the addition of a spectrally selective coating;

FIG. 6C is a cross-sectional view of FIG. 6A with the addition of a removable spectrally selective film;

FIG. 6D is a cross-sectional view of FIG. 6A with the addition of a spectrally selective coating and removable spectrally selective film;

FIG. 7A is a cross-sectional view of a thermochromic and photochromic laminate or co-extrusion whereby the exterior thermochromic, adhesive layer which may contain an additional thermochromic system, and photochromic layer are segregated by suitable separator layers whereby the interior substrate is not required;

FIG. 7B is a cross-sectional view of FIG. 7A with the addition of a spectrally selective coating;

FIG. 7C is a cross-sectional view of FIG. 7A with the addition of a removable spectrally selective film;

FIG. 7D is a cross-sectional view of FIG. 7A with the addition of a spectrally selective coating and removable spectrally selective film;

FIG. 8A is a cross-sectional view of a thermochromic laminate or coextrusion whereby the exterior thermochromic, adhesive layer which may contain an additional thermochromic system are segregated by a suitable separator and photochromic layer is attached to the adhesive and interior substrate layers;

FIG. 8B is a cross-sectional view of FIG. 8A with the addition of a spectrally selective coating;

FIG. 8C is a cross-sectional view of FIG. 8A with the addition of a removable spectrally selective film;

FIG. 8D is a cross-sectional view of FIG. 8A with the addition of a spectrally selective coating and removable spectrally selective film;

FIG. 9A is a cross-sectional view of a thermochromic and photochromic laminate or coextrusion whereby the exterior thermochromic layer is segregated from the photochromic layer by the outside substrate and the photochromic layer is attached to outside substrate;

FIG. 9B is a cross-sectional view of FIG. 9A with the addition of a spectrally selective coating;

FIG. 9C is a cross-sectional view of FIG. 9A with the addition of a removable spectrally selective film;

FIG. 9D is a cross-sectional view of FIG. 9A with the addition of a spectrally selective coating and removable spectrally selective film;

FIG. 10A is a cross-sectional view of a thermochromic and photochromic laminate or coextrusion whereby the exterior thermochromic and adhesive layer which may contain an additional thermochromic system, are segregated by the outside substrate and the photochromic layer is attached to the adhesive layer;

FIG. 10B is a cross-sectional view of FIG. 10A with the addition of a spectrally selective coating;

FIG. 10C is a cross-sectional view of FIG. 10A with the addition of a removable spectrally selective film;

FIG. 10D is a cross-sectional view of FIG. 10A with the addition of a spectrally selective coating and removable spectrally selective film;

FIG. 11A is a cross-sectional view of a thermochromic and photochromic laminate or coextrusion whereby the exterior thermochromic, adhesive layer which may contain an additional thermochromic system, and photochromic layer are segregated by the outside substrate and a suitable separator layer;

FIG. 11B is a cross-sectional view of FIG. 11A with the addition of a spectrally selective coating;

FIG. 11C is a cross-sectional view of FIG. 11A with the addition of a removable spectrally selective film;

FIG. 11D is a cross-sectional view of FIG. 11A with the addition of a spectrally selective coating and removable spectrally selective film;

FIG. 12A is a cross-sectional view of a thermochromic and photochromic laminate or coextrusion whereby the thermochromic and photochromic systems are separate layers without the need for any substrates;

FIG. 12B is a cross-sectional view of FIG. 12A with the addition of a spectrally selective film;

FIG. 13A is a cross-sectional view of a thermochromic laminate or coextrusion whereby the exterior thermochromic, adhesive layer which may contain an additional thermochromic system are segregated by a suitable separator and photochromic layer is attached to the adhesive layer without the need for any substrates;

FIG. 13B is a cross-sectional view of FIG. 13A with the addition of a spectrally selective film;

FIG. 14A is a cross-sectional view of a thermochromic and photochromic laminate or coextrusion whereby the exterior thermochromic, adhesive layer which may contain an additional thermochromic system, and photochromic layer are segregated by suitable separator layers without the need for any substrate layers;

FIG. 14B is a cross-sectional view of FIG. 14A with the addition of a spectrally selective film;

FIG. 15 is a cross-sectional view of a synergistic reversible chromism window system having the absorbing pane positioned as the exterior pane of the window construction to minimize heat transfer from the laminate constructions shown in FIGS. 1 through 14;

FIG. 16 is a cross-sectional view of a synergistic reversible chromism window system having the absorbing pane positioned as the interior pane of the window construction to meet overhead glazing requirements with laminate constructions shown in FIGS. 1 through 14;

FIG. 17A is a cross-sectional view of a double pane window system having the thermochromic absorbing pane positioned as the exterior pane of the window construction whereas the photochromic system is a film placed on the interior surface of the window system;

FIG. 17B is a cross-sectional view of FIG. 17A with the addition of a removable spectrally selective film;

FIG. 17C is a cross-sectional view of FIG. 17A with the addition of a spectrally selective coating;

FIG. 17D is a cross-sectional view of FIG. 17A with the addition of a spectrally selective coating and removable spectrally selective film;

FIG. 18A is a cross-sectional view of a double pane window system having the thermochromic absorbing pane positioned as the exterior pane of the window construction whereas the photochromic system is a film placed on the interior pane of the insulated gas or vacuum space of the window system;

FIG. 18B is a cross-sectional view of FIG. 18A with the addition of a removable spectrally selective film;

FIG. 18C is a cross-sectional view of FIG. 18A with the addition of a spectrally selective coating;

FIG. 18D is a cross-sectional view of FIG. 18A with the addition of a spectrally selective coating and removable spectrally selective film;

FIG. 19A is a cross-sectional view of a double pane window system having the thermochromic absorbing pane positioned as the exterior pane of the window construction whereas the photochromic system is a laminated interior pane of the window system;

FIG. 19B is a cross-sectional view of FIG. 19A with the addition of a removable spectrally selective film;

FIG. 19C is a cross-sectional view of FIG. 19A with the addition of a spectrally selective coating;

FIG. 19D is a cross-sectional view of FIG. 19A with the addition of a spectrally selective coating and removable spectrally selective film;

FIG. 20 is a cross-sectional view of a synergistic reversible chromism window system having the absorbing pane positioned as the exterior pane of the window construction to minimize heat transfer from the laminate constructions shown in FIGS. 1 through 14;

FIG. 21 is a cross-sectional view of a synergistic reversible chromism window system having the absorbing pane positioned as the cavity divider pane of the window construction as illustrated in FIGS. 1 through 14;

FIG. 22 is a cross-sectional view of a synergistic reversible chromism window system having the absorbing pane positioned as the interior pane of the window construction to meet overhead glazing requirements with laminate constructions shown in FIGS. 1 through 14;

FIG. 23A is a cross-sectional view of a three or more pane window system having the thermochromic absorbing pane positioned as the exterior pane of the window construction whereas the photochromic system is a film placed on the interior surface of the window system;

FIG. 23B is a cross-sectional view of FIG. 23A with the addition of a removable spectrally selective film;

FIG. 23C is a cross-sectional view of FIG. 23A with the addition of a spectrally selective coating;

FIG. 23D is a cross-sectional view of FIG. 23A with the addition of a spectrally selective coating and removable spectrally selective film;

FIG. 24A is a cross-sectional view of a three or more pane window system having the thermochromic absorbing pane positioned as the exterior pane of the window construction whereas the photochromic system is a laminated interior pane of the window system;

FIG. 24B is a cross-sectional view of FIG. 24A with the addition of a removable spectrally selective film;

FIG. 24C is a cross-sectional view of FIG. 24A with the addition of a spectrally selective coating;

FIG. 24D is a cross-sectional view of FIG. 24A with the addition of a spectrally selective coating and removable spectrally selective film;

FIG. 25A is a cross-sectional view of a three or more pane window system having the thermochromic absorbing pane positioned as the exterior pane of the window construction whereas the photochromic system is a laminated or coextruded cavity divider pane of the window system;

FIG. 25B is a cross-sectional view of FIG. 25A with the addition of a removable spectrally selective film;

FIG. 25C is a cross-sectional view of FIG. 25A with the addition of a spectrally selective coating;

FIG. 25D is a cross-sectional view of FIG. 25A with the addition of a spectrally selective coating and removable spectrally selective film;

FIG. 26A is a cross-sectional view of a three or more pane window system having the thermochromic absorbing pane positioned as the exterior pane of the window construction whereas the photochromic system is a suspended film cavity divider pane of the window system;

FIG. 26B is a cross-sectional view of FIG. 26A with the addition of a removable spectrally selective film;

FIG. 26C is a cross-sectional view of FIG. 26A with the addition of a spectrally selective coating;

FIG. 26D is a cross-sectional view of FIG. 26A with the addition of a spectrally selective coating and removable spectrally selective film.

FIG. 27 is a graph showing the spectral transmission of a PC layer and a TC layer in one embodiment.

FIG. 28 is a graph showing PC layer transmission percent as function of exposure to UV radiation.

FIG. 29 is a graph of laminate temperature for a thermochromic and a thermochromic photochromic hybrid laminate.

FIG. 30 is a cross-sectional view of a window construction employing a laminate of a blue TC layer, a PC (VersaTint™) layer and an orange TC layer.

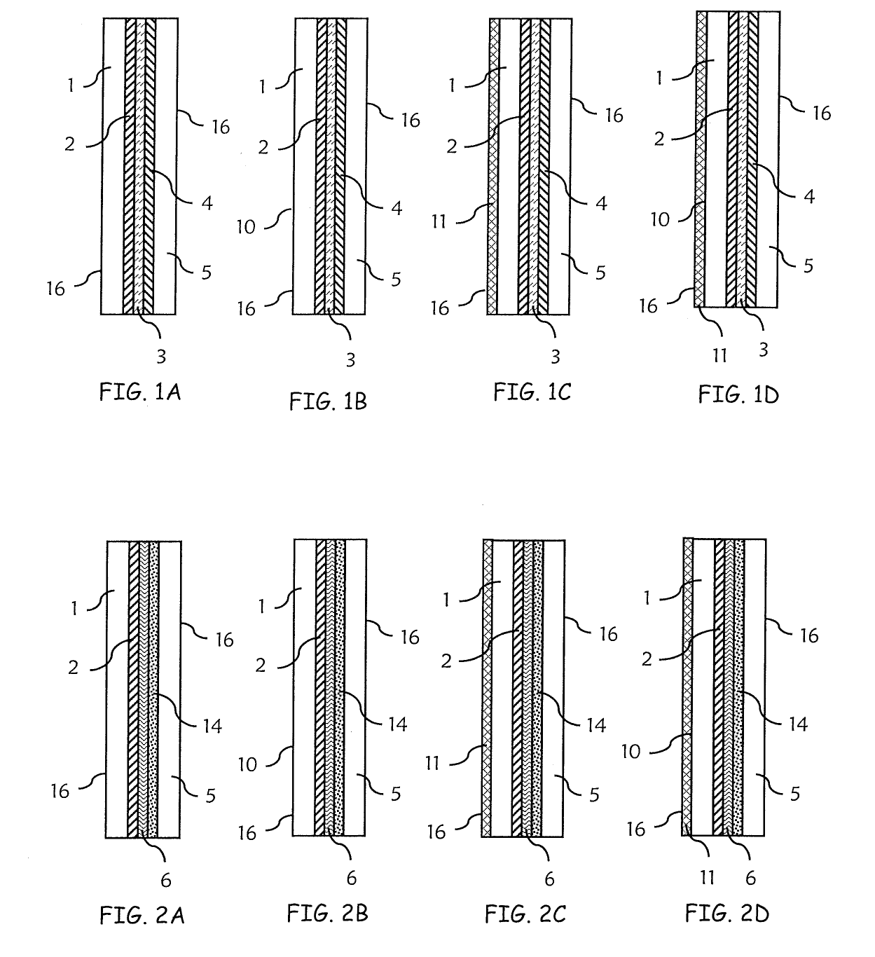

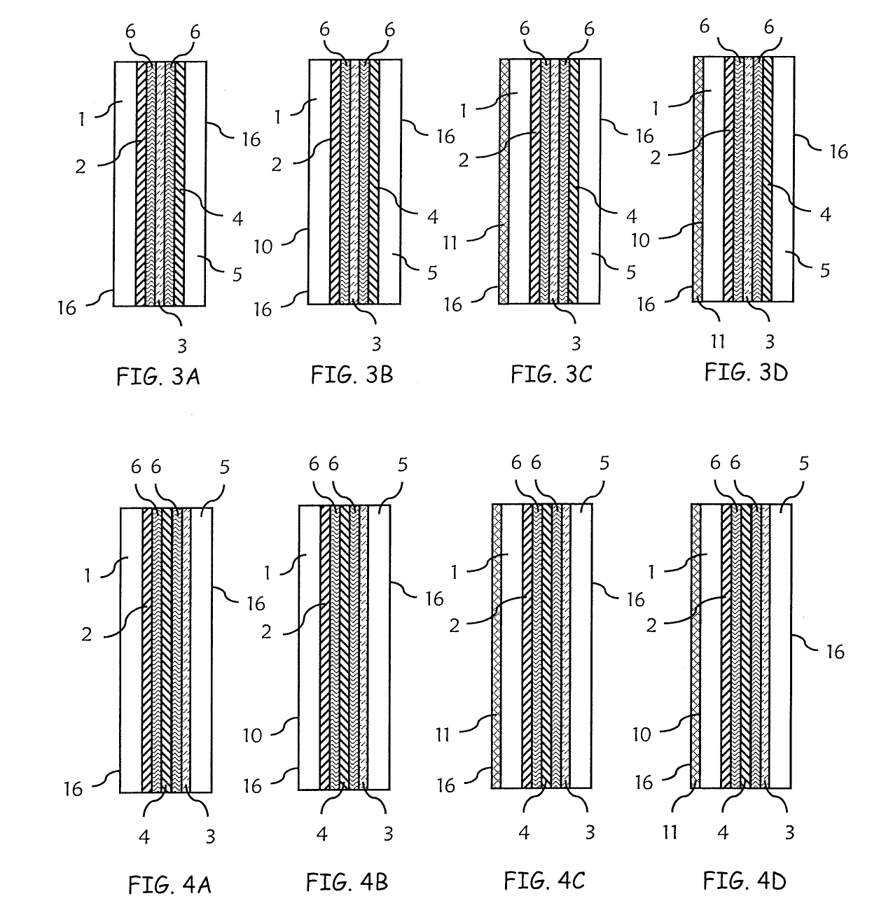

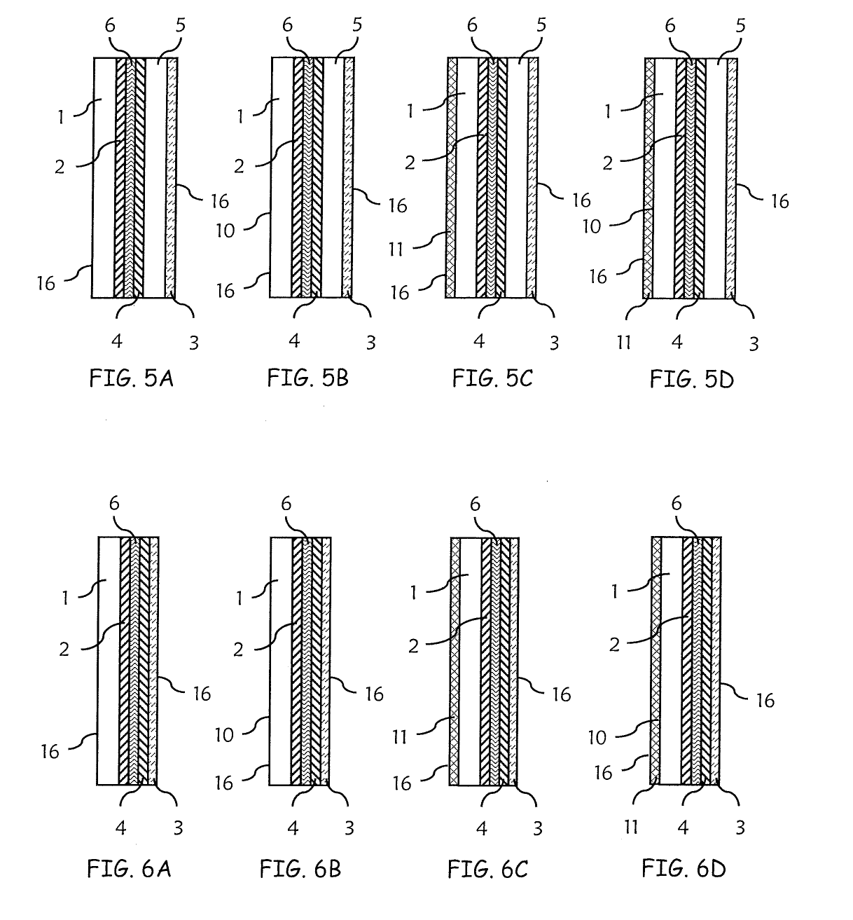

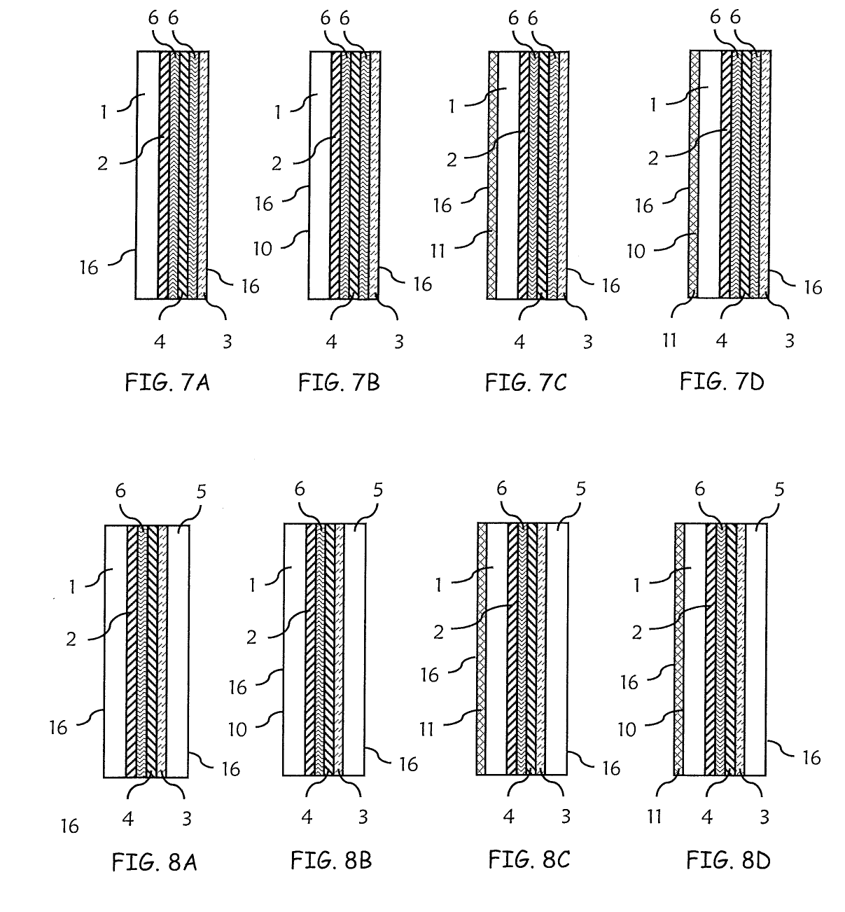

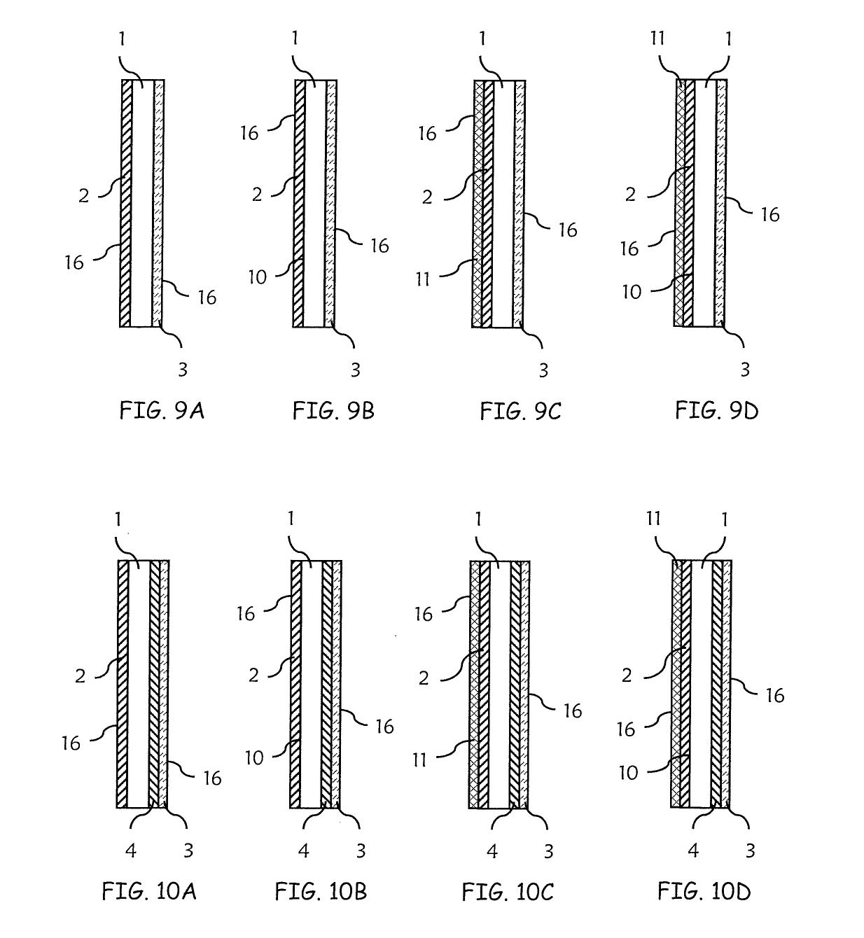

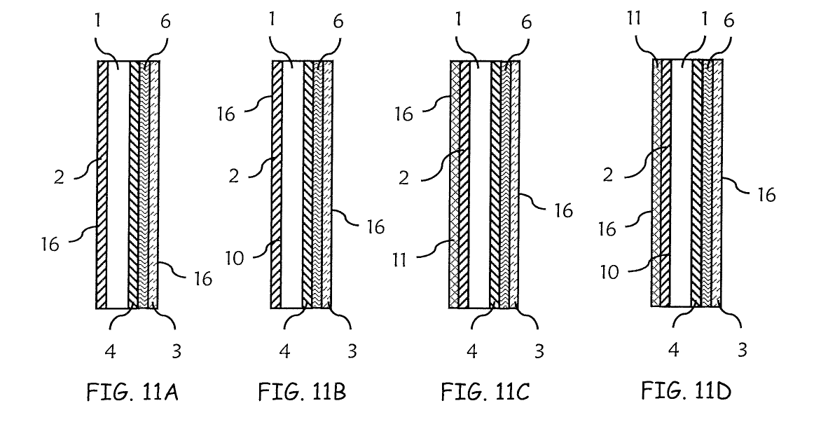

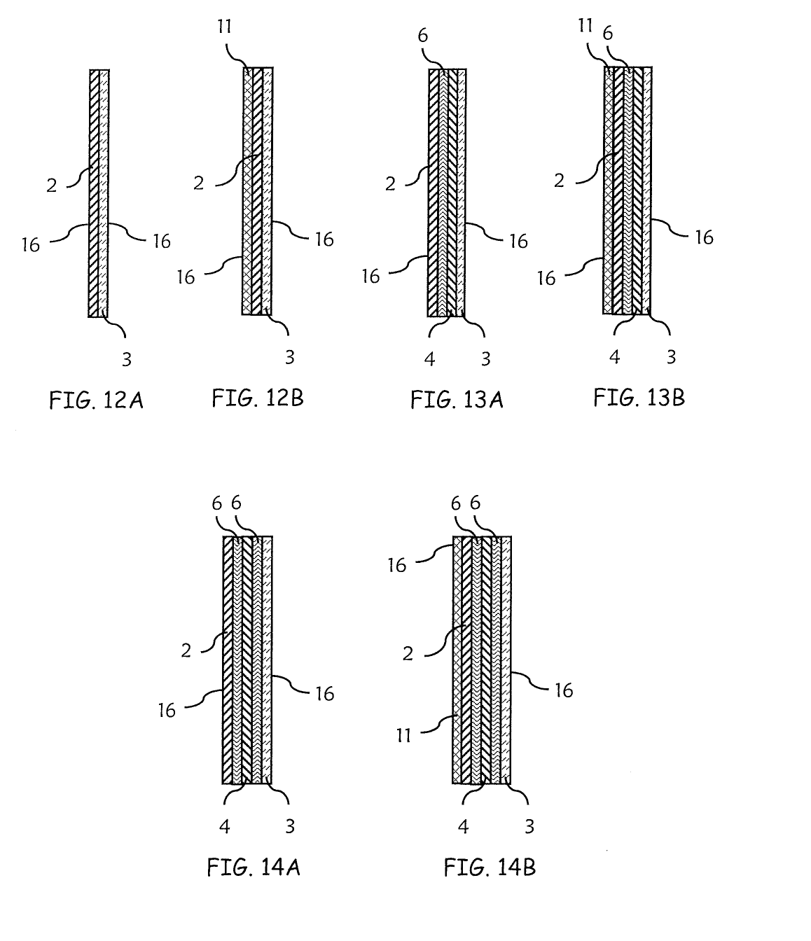

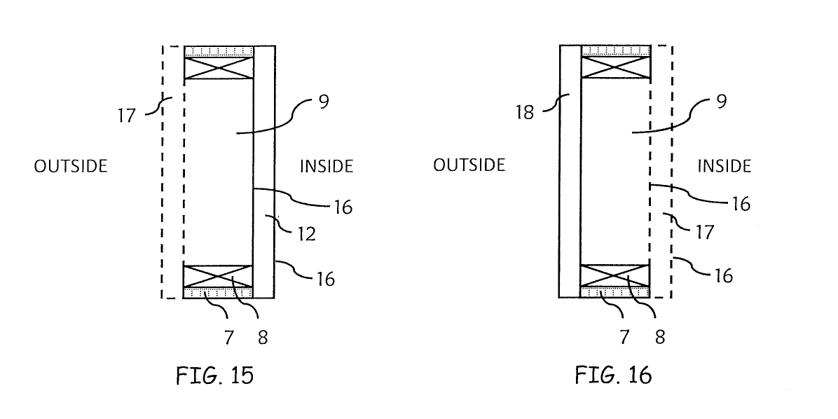

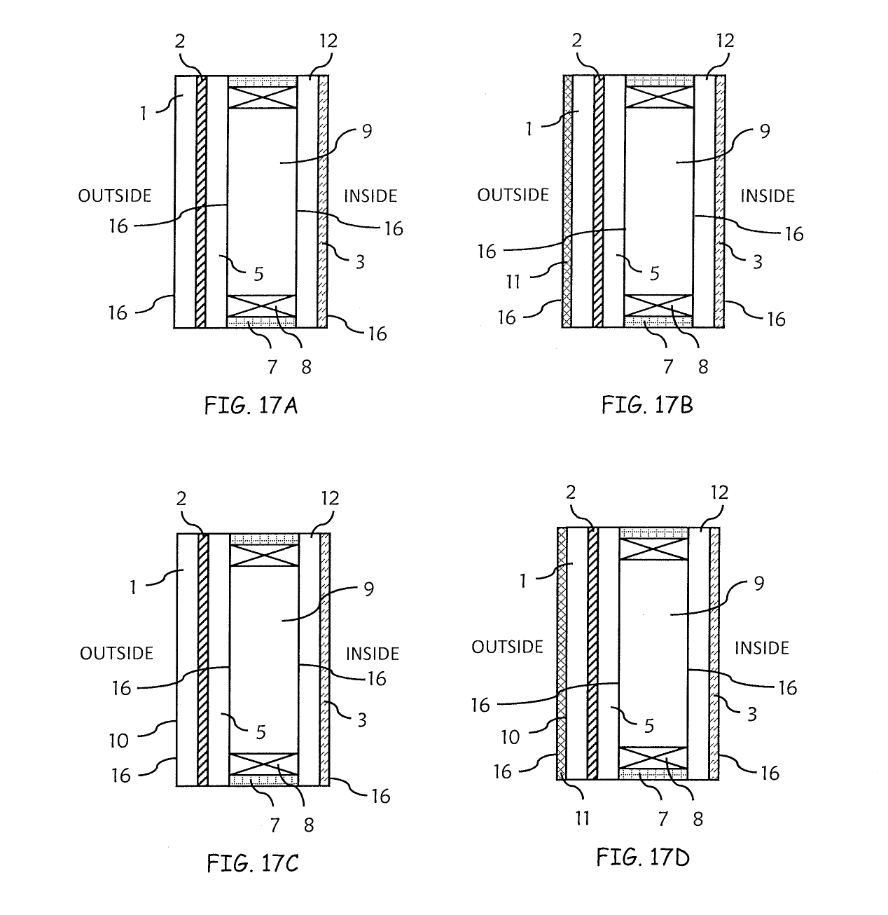

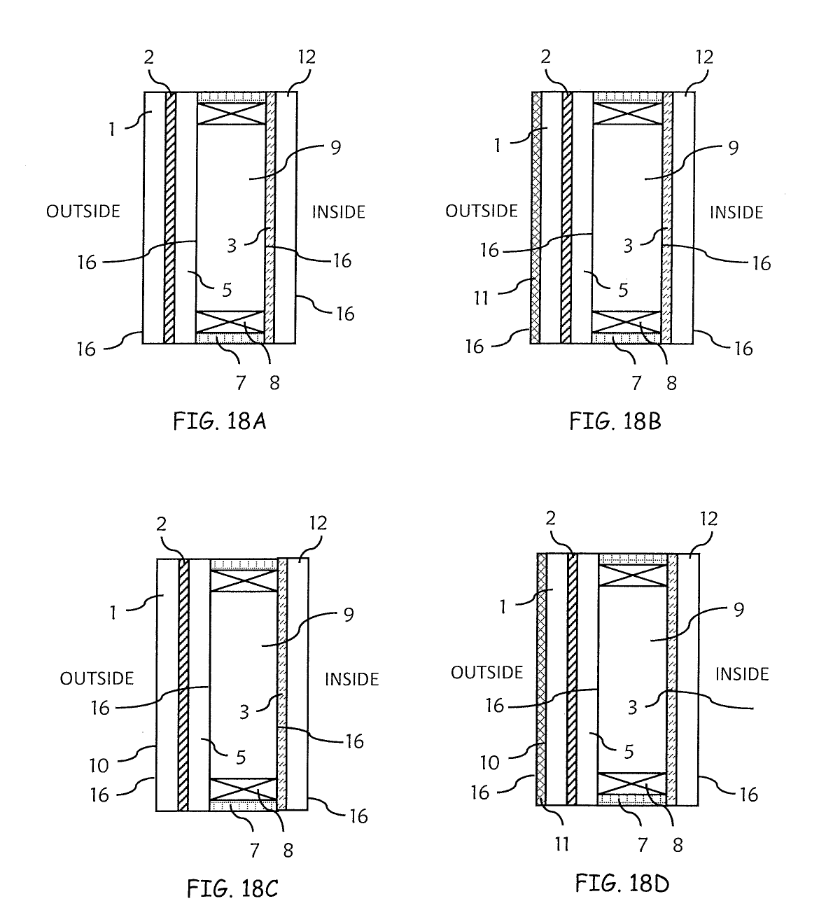

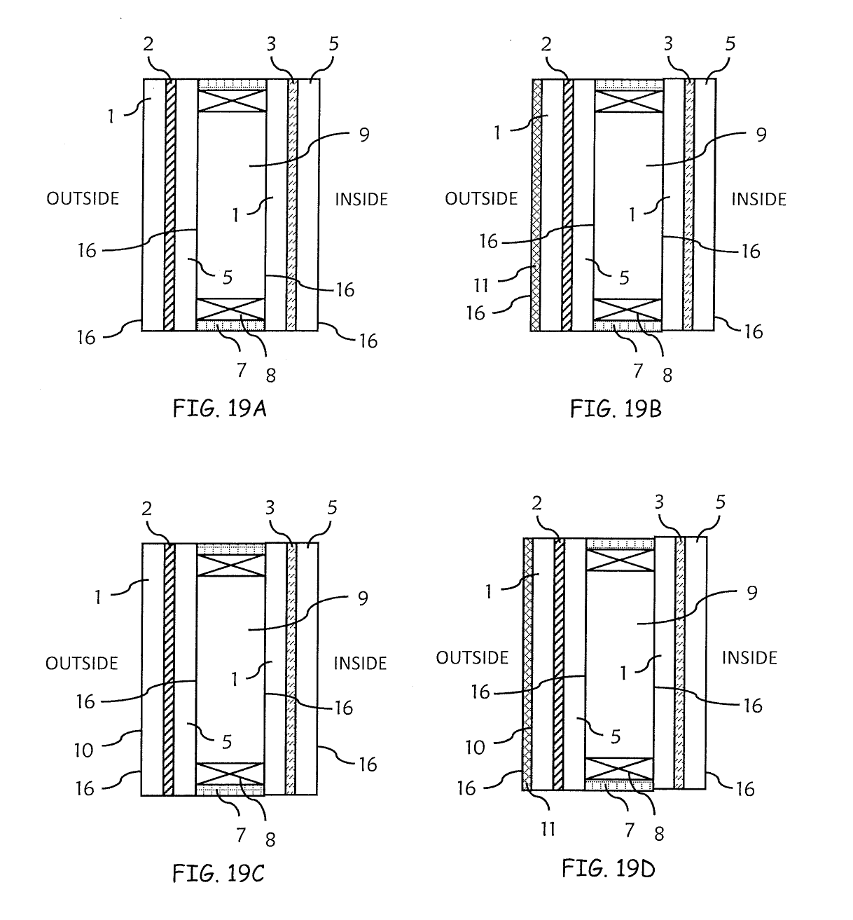

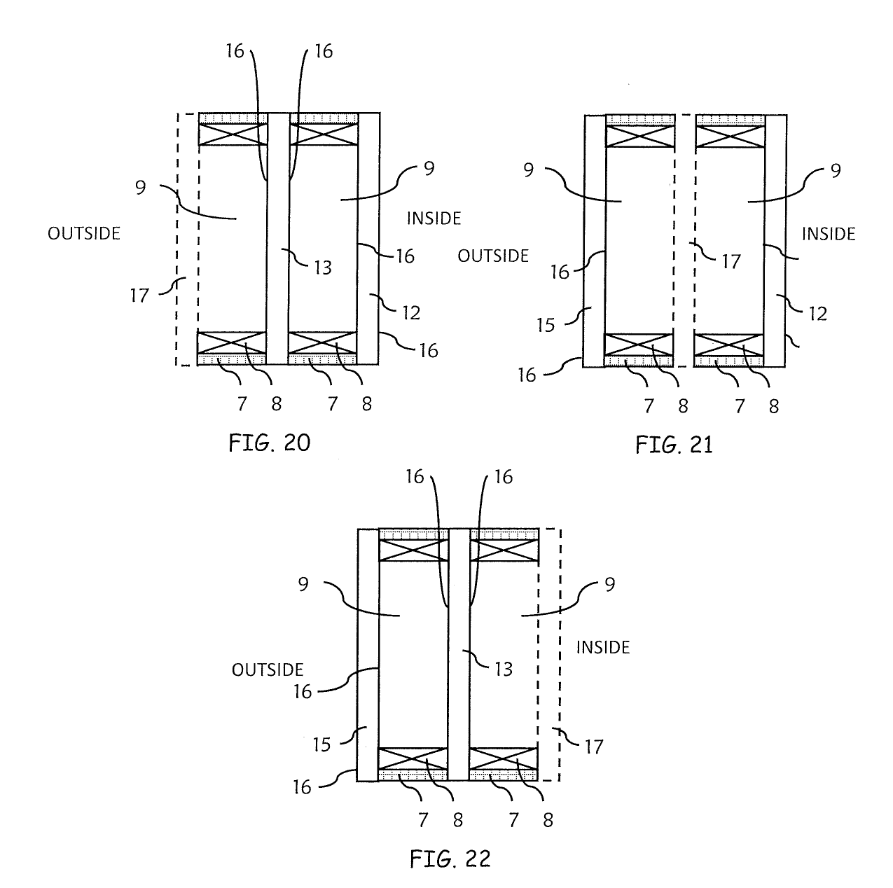

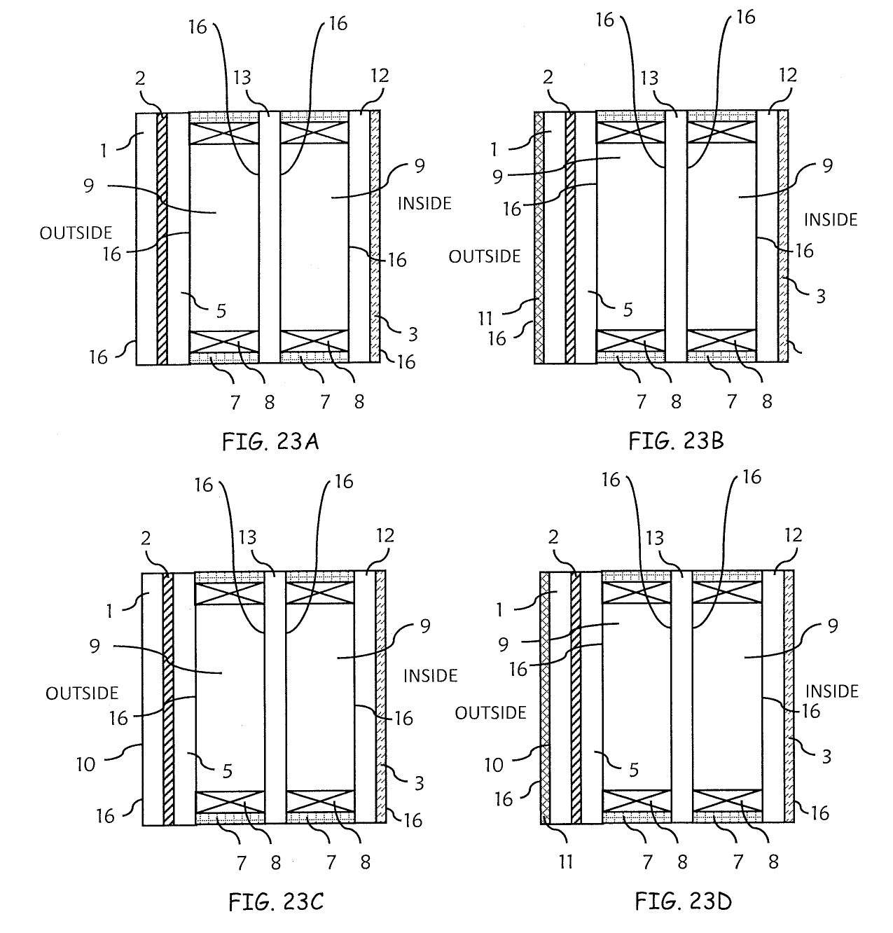

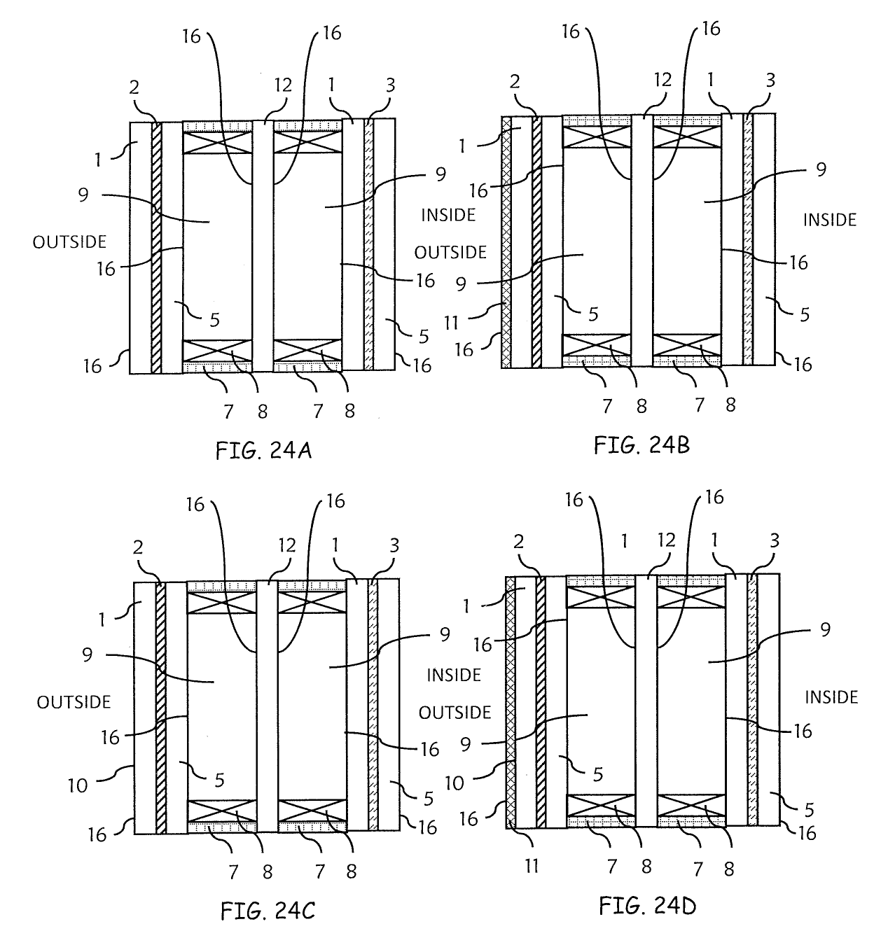

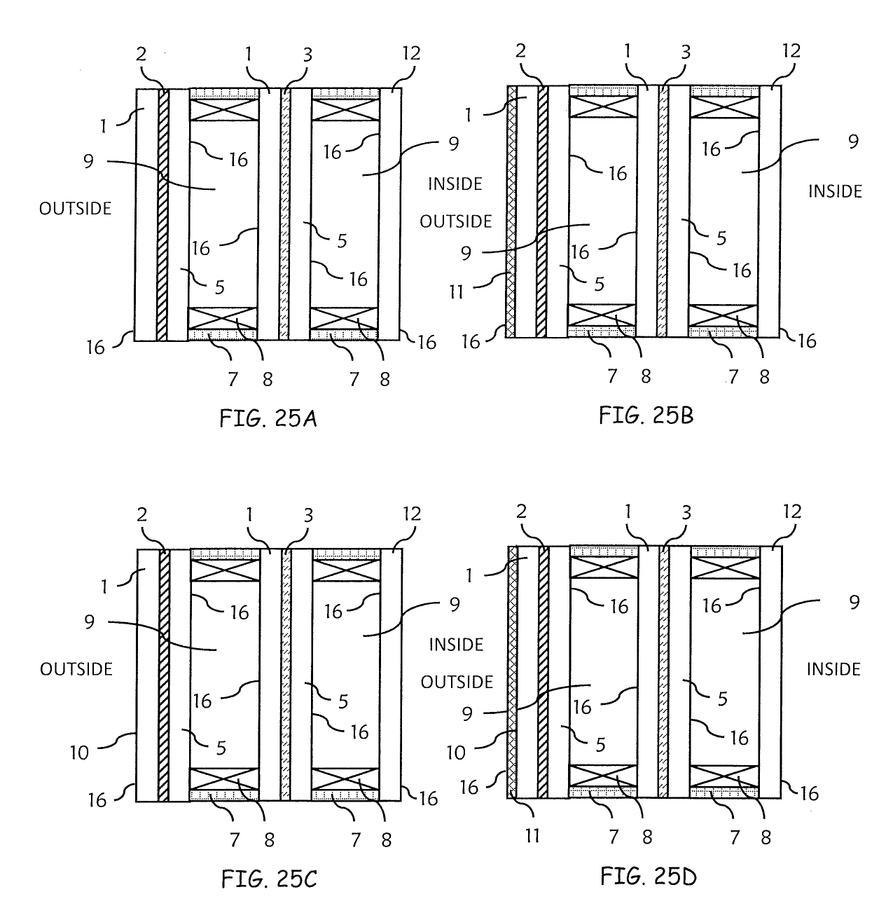

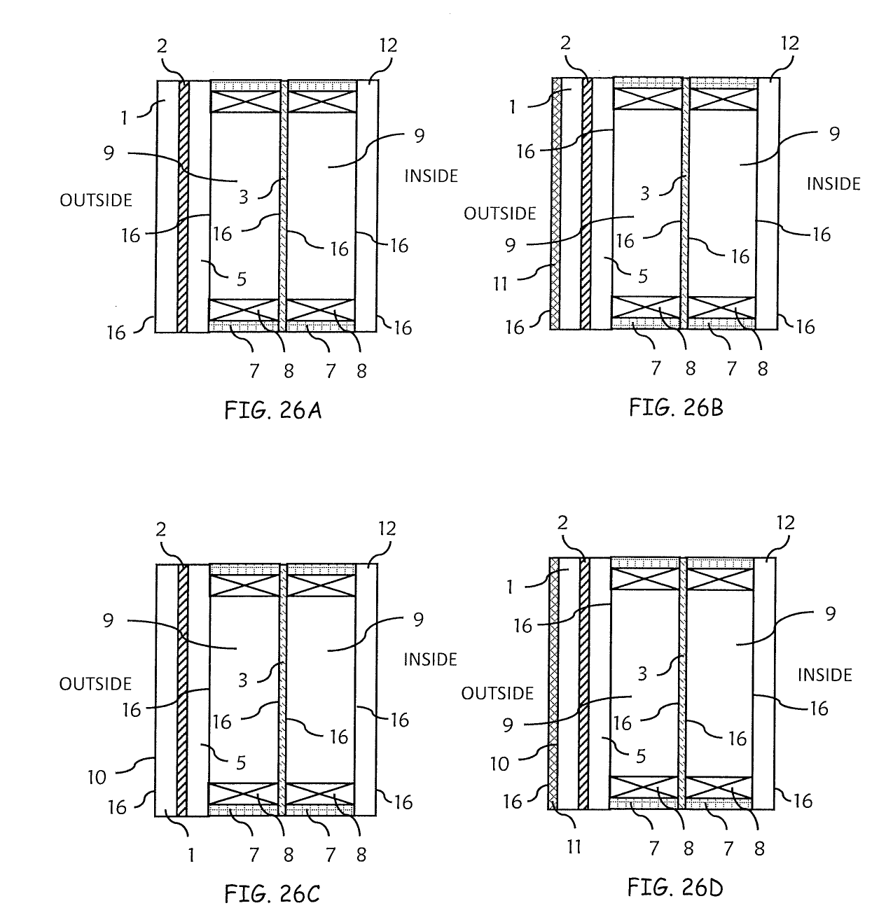

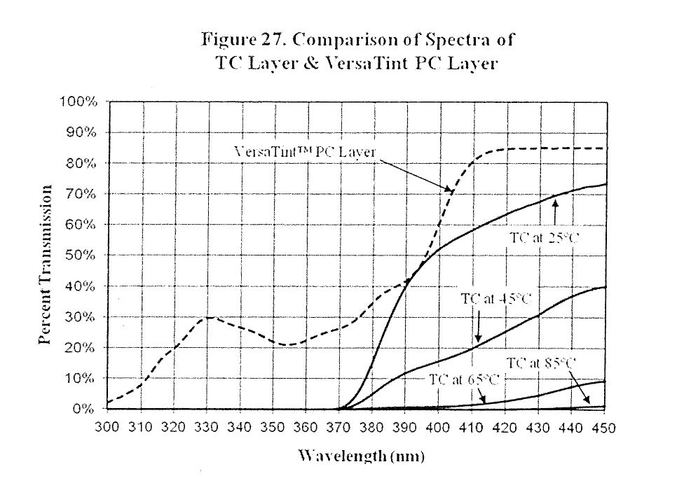

### DETAILED DESCRIPTION

A window was prepared by pre-laminating together two TC layers separated by a VersaTint™ PC film that was atmospheric plasma surface treated as described above. This pre-laminate was used to laminate two sheets of glass together to make a window pane. The window pane was exposed to light and heat in a Ci65A Weather-ometer, (WOM), from Atlas Material Testing Technology, LLC of Chicago, Ill. The WOM uses a Xenon arc lamp which was operated 0.55 watts/square meter at 340 nanometers, (nm), and the temperature in WOM was controlled to give a black panel temperature of 85° C. This is designated as WOM exposure. The TC layer that faced the Xenon arc lamp had following composition: 2 weight % nickel(II) iodide; 1 weight % 4-(3-phenylpropyl)pyridine; 12.5 weight % tetrabutylammonium iodide; 3.5% 2-butyl-2-ethyl-propanediol; 1 weight % Tinuvin 405; 13 weight % non-TC additives and 67 weight % poly(vinyl butyral). Spectra for the window pane were measured at 25° C. and 65° C. before and after various lengths of WOM exposure. There was no activation of the PC layer during this set of spectral measurements so only the TC performance and durability were measured. From the spectra, the data in Table 1 were calculated. These data show a very promising level of durability.

TABLE 1
Color and Visible Light Transmission of Laminate Composed
of Two TC Films Separated by an Atmospheric Plasma Treated
VersaTint ™ film.

| | | a* | b* | Y |
|---|---|---|---|---|
| | | 25° C. | | |
| 0 | hrs | −7.0 | 2.9 | 70.8 |
| 503 | hrs | −7.3 | 5.3 | 66.6 |
| 1145 | hrs | −7.5 | 5.8 | 66.5 |
| 2001 | hrs | −7.7 | 5.8 | 66.9 |
| | | 65° C. | | |
| 0 | hrs | −6.3 | 3.0 | 14.6 |
| 503 | hrs | −7.6 | 3.0 | 13.0 |
| 1145 | hrs | −9.4 | 2.0 | 14.1 |
| 2001 | hrs | −10.9 | −0.3 | 14.8 |

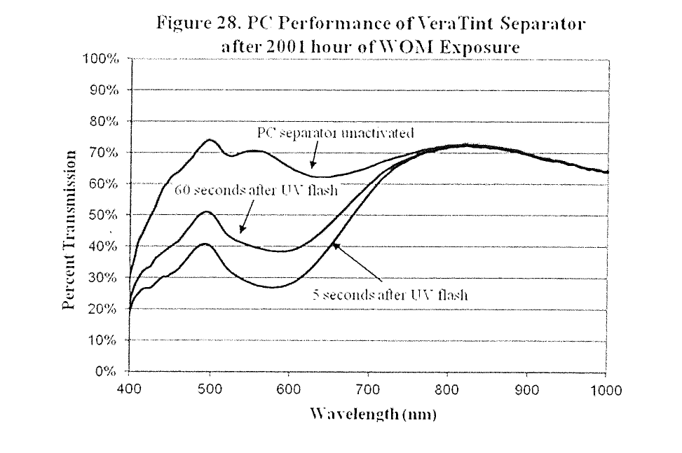

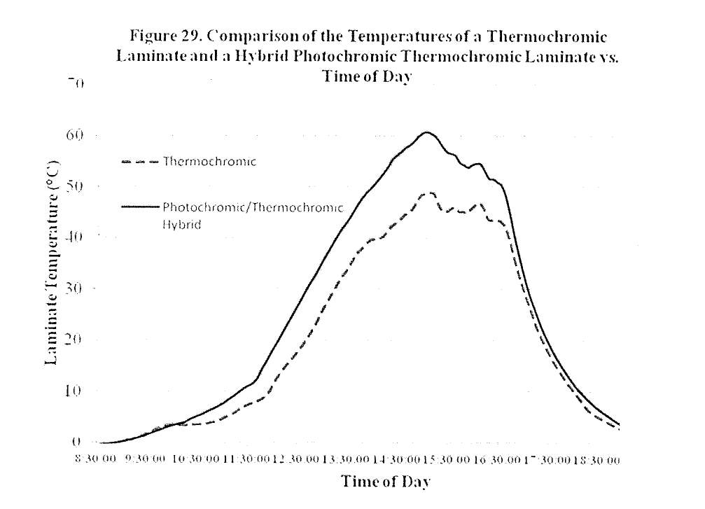

After 2001 hours of WOM exposure the spectra of the window pane was measure at 25° C. before exposure to a UV flash lamp, five seconds after exposure to a UV flash lamp and sixty seconds after exposure to a UV flash lamp. The spectra due to the PC activation of the VersaTint™ film separator in the laminate are shown in FIG. 28.

Visual observation of the PC performance of the separator after 2001 hours of WOM exposure gave the impression that the performance was at least as good as it was before the WOM exposure. This is a remarkable durability result as a piece of the same PC film directly exposed in the WOM lost all PC activity within 1 hour.

The following example shows how the PC layer can enhance the sunlight responsiveness of the TC layer. The darkening of a TC layer is directly related to the temperature of the TC layer. The higher the temperature of the TC layers of the present invention the lower the visible transmission of the layer becomes. FIG. 29 shows the temperature versus time of day for a window pane with same two TC layers throughout the pane. On half the pane the TC layers were separated with polyethylene terephthalate with no PC materials present and for the other half of the pane the TC layers were separated by a surface treated, adhesion promoted layer of VersaTint™ PC film. As FIG. 29 shows the combination of TC and PC layers is warmer and darker than the TC layers alone on a day in January.

### Example 1

Sunny Day

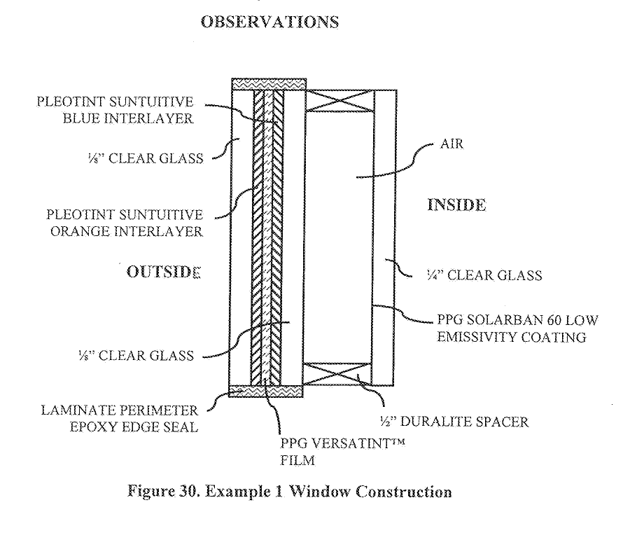

A window with the construction shown in FIG. 30 was placed outdoors at approximately 60° tilt facing south at 11:00 am. The test was conducted in Jenison, Mich. in November. The conditions were mostly sunny. The outdoor temperature was measured to be 4° C. The visible light transmission was measured with an EDTM Window Energy Profiler (Model No. WP4500). The initial visible light transmission (before exposure) was 53% visible light transmission. A second reading of the laminate was taken after outdoor sunlight exposure of one hour. The visible light transmission was reduced to 11%. The laminate temperature was measured to be 4.4° C. A change in tinting was noticeable within 2 minutes of outdoor exposure. Based on the known TC characteristics of the TC systems, the tinting must be due almost entirely to the darkening of the PC layer.

Cloudy Day

The construction shown above was placed outdoors at approximately 60° tilt facing south at 9:00 am. The test was conducted in Jenison, Mich. in December. The conditions were cloudy. The outdoor temperature was measured to be 3° C. The visible light transmission was measured with an EDTM Window Energy Profiler (Model No. WP4500). The initial visible light transmission (before exposure) was 53% visible light transmission. A second reading of the insulated glass unit was taken after outdoor exposure of one hour. The visible light transmission was reduced to 39%. The laminate temperature was measured to be 3° C. A change in tinting was noticeable within 2 minutes of outdoor exposure.

### Example 2

A laminate was constructed of two pieces of 3 mm float glass laminated together with a layer of TC film, a layer of VersaTint™ film and another layer of TC film. The laminate was subsequently made into an insulated glass unit (IGU) with ½″ airspace and 6 mm piece of PPG Solarban 60, analogously to the IGU shown in FIG. 30.

Visible light transmission measurements were obtained with an EDTM Energy Transmission Meter (Model No. PR3400). The visible light transmission of the IGU was 73% in the clearest state. Placed outside on an overcast day with an ambient temperature of ca. 5° C. for 1 h, the visible light transmission decreased to 32%. This was almost exclusively due to the PC layer, as the laminate temperature was less than 25° C. After removing from sunlight exposure, the part returned to the clearest state after ca. 25 min at 25° C.

The visible light transmission of the IGU at elevated temperatures were as follows: 51% at 45° C., 36% at 55° C. and 23% at 65° C. In addition, this IGU darkened rapidly during exposure to simulated sunlight (Xe arc lamp). After just 30 s of exposure, the visible light transmission of the IGU was 42% with a laminate temperature of 29° C.

### Example 3

Observations of hybrid PC/TC window system installed in West Olive, Mich. with the following construction: 3 mm clear glass w/Cardinal 181 coating on exterior surface laminated to 3 mm clear glass with Pleotint TC interlayer with a ½″ air space and a 3 mm Cardinal LowE-366 pane of glass with a laminate composed of two pieces of 1 mm clear glass with a thin film of 1% Palatinate Purple photochromic dye, available from Keystone Aniline Corporation (Chicago, Ill.), in cellulose acetate butyrate adhered to the inner pane. With overcast conditions, neither the TC layers nor the PC layer appear to darken to any significant extent. With clear conditions and direct sun, the photochromic layer darkens to about 50% of its minimum transmittance prior to a perceptible change in the thermochromic layer. As the TC layer darkens, the photochromic response is significantly reduced. Under simulated solar conditions (700 W halogen lamp), short exposure of 5 seconds led to modest response of the PC layer, (30-50% of minimum transmittance), without a perceptible change in the TC layer. Longer exposures to the halogen lamp of 60 seconds resulted in significant darkening of the TC layer, (ca. 20% visible light transmission), and little to no darkening of the photochromic layer.

Having described the invention in detail and by reference to preferred embodiments thereof, it will be apparent that modifications and variations are possible without departing from the scope of the invention as defined by the following claims.

What is claimed is:

1. A multilayer laminate which comprises
a) a thermochromic layer
b) a photochromic layer
wherein the thermochromic layer exhibits a net increase in its ability to absorb UV, visible, and/or near infrared light energy as the temperature of the system increases and a net decrease in its ability to absorb UV, visible and/or near infrared light energy as the temperature of the system decreases within the active range of the thermochromic layer and wherein the thermochromic layer is between sun and the photochromic layer and wherein the thermochromic layer protects the photochromic layer from more harmful solar radiation when the thermochromic layer is warm and wherein the thermochromic layer transmits some long wavelength UV when cool.

2. The multilayer laminate of claim 1 wherein the photochromic layer forms a separator between multiple thermochromic layers.

3. The multilayer laminate of claim 1 wherein the photochromic layer is protected from oxygen.

4. The multilayer laminate of claim 1 wherein the photochromic layer is surface treated to promote adhesion.

5. The multilayer laminate of claim 1 wherein the multilayer laminate is laminated between sheets of glass to form a pane.

6. The pane of claim 5 wherein the pane is installed as part of a window in a building.
